(19) United States
(12) Patent Application Publication
(10) Pub. No.: US 2026/0035963 A1
(43) Pub. Date: Feb. 5, 2026

(54) REPLACEMENT STOREFRONT DOOR LOCK WITH NO DRILLING

(71) Applicant: AISECURE INC., ANAHEIM, CA (US)

(72) Inventor: Dezhao Xiang, ANAHEIM, CA (US)

(21) Appl. No.: 19/358,475

(22) Filed: Oct. 15, 2025

Related U.S. Application Data
(63) Continuation-in-part of application No. 18/954,561, filed on Nov. 21, 2024.
Application No. 18/954,561 is a continuation-in-part of application No. PCT/CN2024/131010, filed on Nov. 8, 2024.

(30) Foreign Application Priority Data
May 29, 2025 (CN) 202521084016.5
Jul. 8, 2025 (CN) 202521430009.6

(51) Int. Cl. E05B 63/08; E05B 63/00

(52) U.S. Cl. CPC E05B 63/08; E05B 63/0056; E05Y 2900/11

(57) ABSTRACT

A replacement storefront door lock with no drilling is provided. The replacement storefront door lock with no drilling includes an outdoor component; an indoor component; a mortise including a housing, a bolt and a drive shift, the bolt movably disposed in the housing; a tailpiece; and an electronic assembly including a main circuit board, a motor located in the indoor component and a command-signal verification element located on the outdoor component. The motor and the command-signal verification element are electrically connected to the main circuit board. A conductor connected to the main circuit board passes through a wire hole of the housing to transmit electronic signal. The replacement storefront door lock with no drilling in this application can replace old lock without drilling new holes; with the conductors, the replacement storefront door lock with no drilling can be a smart lock.

### CROSS-REFERENCE TO RELATED APPLICATIONS

The present application is a Continuation in part application of U.S. patent application Ser. No. 18/954,561, filed on Nov. 21, 2024, which is a Continuation in part application of PCT Application No. PCT/CN2024/131010, filed on Nov. 8, 2024, which claims the priority of Chinese Patent Application No. 202410123874.X, filed on Jan. 29, 2024, and claims priorities of Chinese Patent Application No. 202521084016.5, filed on May 29, 2025, and Chinese Patent Application No. 202521430009.6, filed on Jul. 8, 2025, the entire contents of which are hereby incorporated by reference.

### TECHNICAL FIELD

The present disclosure relates to the technical field of locks, and in particular to a replacement storefront door lock with no drilling.

### BACKGROUND

A lock refers to an apparatus used to secure a door or entryway, consisting of components such as a mortise, indoor and outdoor components, a lock cylinder, a key and accessories etc. A lock (typically an Adams Rite storefront mortise lock) has already been installed on store doors, and most stores are usually rented properties. Generally, store's doors are aluminum alloy doors, and an aluminum alloy door consists of aluminum alloy frame and glass panel assembled to the aluminum alloy frame. When a new smart lock (including mechanical smart locks and electronic smart locks) is installed in replace of the original Adams Rite mortise lock, there are two core issues: firstly, landlords typically prohibit tenants from drilling holes in storefront doors; and secondly, even if permitted, the process is costly and subject to various regulatory approvals. Therefore, a replacement lock capable of directly being installed without drilling holes and easy to install is an optimal choice.

With the development of technology, a storefront door needs a keyless lock or more intelligent smart locks to solve problems of having to give the keys to employees to lock the door or having to rush back to the shop to lock the door at midnight when stores managers who have to leave work early due to urgent matters. Currently, in metal storefront door lock, an indoor component and an outdoor component are independently installed and used at two sides of a mortise structure, and the mortise structure causes the indoor and outdoor components to be not interconnected. The indoor and outdoor components and the mortise structure are not fixed on a same axis, making it impossible to design a keyless lock structure or an electronic lock gear-driven locking or unlocking mechanism. In another storefront door lock, a lock cylinder integrally and directly passes through the mortise structure, and is fixed to the mortise structure via long bolts, resulting in it being inconvenient to connect a motor of an electronic lock to the lock cylinder to achieve keyless locking. In this case, it is necessary to replace the existing Adams Rite mortise lock with no drilling by a mechanical smart lock or an electronic smart lock to meet the usage requirements.

Please referring to FIG. 1 and FIG. 2, an Adams Rite mortise lock 100 is shown. Since the Adam's Rite mortise lock 100 cannot be redesigned as a smart mechanical password lock or an electronic smart lock, merchants usually need to replace the Adam's Rite mortise lock 100 with no drilling with a password lock to achieve keyless entry. When replacing the Adam's Rite mortise lock 100 with a new lock with no drilling, the new lock must have the same outer dimensions as a mortise housing 1001 of the Adam's Rite mortise lock 100 and a center point, a torque, and an angle to open the lock should be re-found. The Adam's Rite mortise lock 100 is installed on a door panel 102. The door panel 102 defines a mortise hole 1021 and a lock cylinder hole 1023. The Adam's Rite mortise lock 100 includes the mortise housing 1001, a bolt 1002, and a lock cylinder 1003. The bolt 1002 is assembled in the mortise housing 1001 and can be extended and retracted to lock or unlock with an opening on the door frame (not shown). The lock cylinder 1003 is rotatably installed in the mortise housing 1001, thus allowing the lock cylinder 1003 to drive the bolt 1002 to extend (i.e. the bolt 1002 moves along a first direction), and to drive the bolt 1002 to retract (i.e. the bolt 1002 moves along a second direction opposite to the first direction). The mortise housing 1001 is installed on the door panel 102 by screws passing through screw holes defined in the mortise housing 1001.

It is obvious that dimensions of the mortise hole 1021, the lock cylinder hole 1023, and the bolt 1002, dimensions of the mortise housing 1001, positions of the screw holes in the mortise housing 1001, relative position of the bolt 1002 and the lock cylinder hole 1023, the existing stroke of the bolt 1002, and position of the bolt 1002 on the mortise are all definite by the original Adam's Rite mortise.

If the original Adam's Rite mortise lock 100 is to be replaced without drilling any holes, it is necessary to conduct an in-depth analysis of the design principles of the original lock. Further, it is also necessary to design a new lock having external dimensions, a stroke of the bolt, a distance of the bolt a position of the bolt, a torque, locking points, screw hole locations, rivet positions, thickness of the components, a diameter of the lock cylinder hole, a door hole, and all other dimensional structures the same as the original Adam's Rite mortise lock 100. In addition, it is required to recalculate the new physical transmission trajectories for the transmission center point, transmission torque, locking points, and locking torque within an extremely limited space, and new installation structures need to be added. In reality, this is quite challenging to achieve.

### SUMMARY

The objective of the present disclosure is to provide a replacement storefront door lock with no drilling that enable the replacement storefront door lock can conveniently replace an old lock such as an ordinary Adam's Rite mortise lock.

To achieve the above purpose, the present disclosure provides a replacement storefront door lock with no drilling, configured to be mounted on a first component of a storefront door so as to lock or unlock the first component relative to a second component. The replacement storefront door lock with no drilling includes:
an outdoor component configured to mounted at an outer side of the first component, a command-signal verification element located on the outdoor component;
an indoor component configured to mounted at an inner side of the first component;
a mortise, disposed between the outdoor component and the indoor component, the mortise comprising a housing, a bolt and a drive shift, the bolt movably disposed in the housing, and the housing defining a wire hole;
a tailpiece, rotatably disposed and engaged with the drive shift, the drive shift configured to receive a driving from the tailpiece to rotate to push the bolt to extend or retract; and
an electronic assembly, comprising a main circuit board, a motor located in the indoor component and the command-signal verification element located on the outdoor component, the motor and the command-signal verification element electrically connected to the main circuit board, and when a verification signal sent by command-signal verification element verified by the main circuit board, the main circuit board sending a command to the motor in the indoor component, and the motor configured to drive the tailpiece to rotate, thereby causing the bolt to extend or retract to open or lock the door;
wherein a conductor connected to the main circuit board passes through the wire hole of the housing to transmit electronic signals.

The present application further provides a replacement storefront door lock, configured to be mounted on a first component of a storefront door so as to lock or unlock the first component relative to a second component. The replacement storefront door lock with no drilling includes:
an outdoor component configured to mounted at an outer side of the first component;
an indoor component configured to mounted at an inner side of the first component;
a mortise, disposed between the outdoor component and the indoor component, the mortise comprising a housing, a bolt and a drive shift, the bolt movably disposed in the housing, and the housing defining a wire hole;
a tailpiece, rotatably disposed and engaged with the drive shift, the drive shift configured to receive a driving from the tailpiece to rotate to push the bolt to extend or retract; and
an electronic assembly, comprising a first electronic element mounted on the indoor component and a second electronic element mounted on the outdoor component, the first electronic element and the second electronic element are electrically connected to each other via a conductor;
wherein the conductor passes through the wire hole of the housing to transmit electronic signals.

In the replacement storefront door lock of this embodiment, the arrangement of the drive shift coupled with the mortise, allows for easy design of the relative position between the lock hole and the extended position of the bolt, as well as the overall size of the mortise. Moreover, it can conveniently re-find the center point, torque, and rotation angle with a high degree of consistency with the old lock. Therefore, the replacement storefront door lock with no drilling of this application can conveniently replace the old lock without the need to drill new holes in the door. Meanwhile, with the arrangement of conductor, the store door may be equipped with a smart lock without drilling holes to replace the old lock. The lock can be opened by means of a password, fingerprint, or facial recognition, achieving keyless locking and unlocking, which greatly enhances the convenience of using the lock.

### BRIEF DESCRIPTION OF DRAWINGS

In order to illustrate the embodiment of the disclosure more clearly, the following is a brief description of the drawings used in the embodiment. Apparently, the drawings described below are only some embodiments of the disclosure, and other drawings can be obtained according to these drawings for the person skilled in the art without creative labor.

FIG. 1 shows an old lock.

FIG. 2 is a schematic view showing the lock of FIG. 1 installed on a door panel.

FIG. 3 is a schematic view of a replacement storefront door lock with no drilling according to a first embodiment of the present disclosure installed in a door panel.

FIG. 4 is a sectional view of FIG. 3.

FIG. 5 is a partially enlarged view of part V in FIG. 4.

FIG. 6 is a schematic, assembled view of the replacement storefront door lock with no drilling of FIG. 3.

FIG. 7 is an exploded view of the replacement storefront door lock with no drilling of FIG. 6 viewing from a direction.

FIG. 8 is an exploded view of the replacement storefront door lock with no drilling of FIG. 6 viewing from another direction.

FIG. 9 is an exploded schematic view of the mortise of the replacement storefront door lock with no drilling of FIG. 7.

FIG. 10 is a schematic view of a drive shift, a drive rod and a torsion spring of the replacement storefront door lock with no drilling of FIG. 3.

FIG. 11 is a plane view of some components of the replacement storefront door lock with no drilling of FIG. 3.

FIG. 12 is an exploded view of a replacement storefront door lock with no drilling according to a second embodiment of the present disclosure viewing from a direction.

FIG. 13 is a schematic view of a drive shift, a drive rod and an elastic member of the replacement storefront door lock with no drilling of FIG. 12.

FIG. 14 is a plane view of part of components of the mortise of the replacement storefront door lock with no drilling of FIG. 12.

FIG. 15 is an exploded view of a replacement storefront door lock with no drilling according to a third embodiment of the present disclosure viewing from a direction.

FIG. 16 is a schematic view of a drive shift, a drive rod and an elastic member of the replacement storefront door lock with no drilling of FIG. 15.

FIG. 17 is a schematic, assembled view of the replacement storefront door lock with no drilling according to a fourth embodiment of the present disclosure.

FIG. 18 is an exploded view of the replacement storefront door lock with no drilling of FIG. 17 viewing from a direction.

FIG. 19 is a schematic view of a drive shift, a drive rod and an elastic member of the replacement storefront door lock with no drilling of FIG. 17.

FIG. 20 is a schematic view of part of components of the mortise of the replacement storefront door lock with no drilling of FIG. 17.

FIG. 21 is an exploded view of a replacement storefront door lock with no drilling according to a fifth embodiment of the present disclosure viewing from a direction.

FIG. 22 is an exploded schematic view of the mortise of the replacement storefront door lock with no drilling FIG. 21.

FIG. 23 is a schematic view of a drive shift, a drive rod and a first reset member of the replacement storefront door lock with no drilling of FIG. 21.

FIG. 24 is a plane view of part of components of the mortise of the replacement storefront door lock with no drilling of FIG. 21.

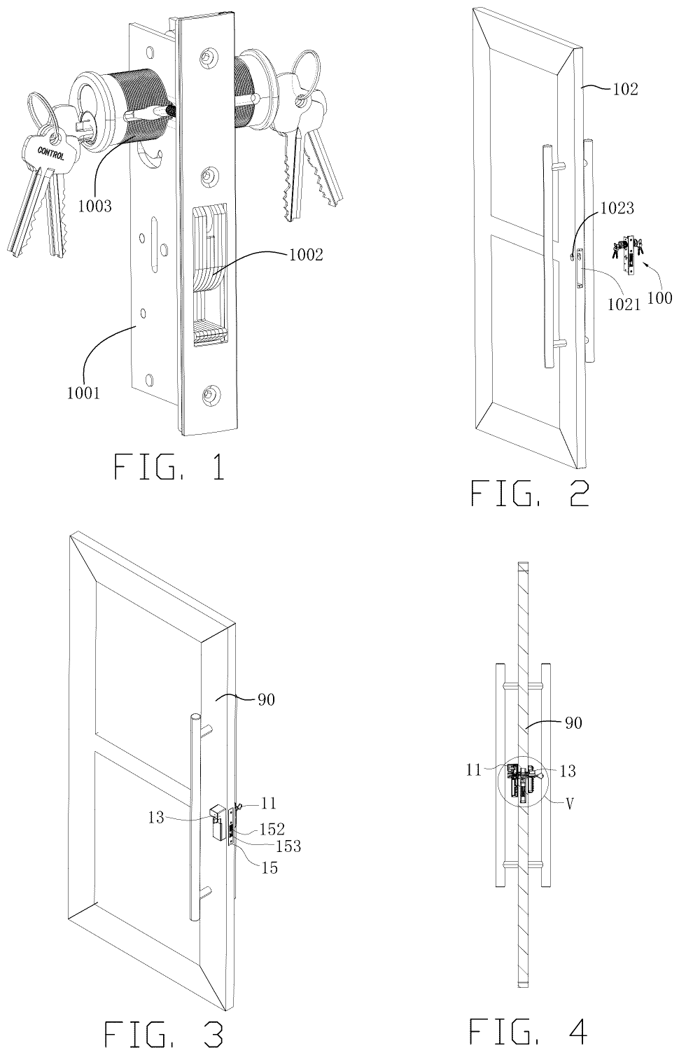

### DESCRIPTION OF EMBODIMENTS

The technical solution in the embodiments of the present application will be clearly and completely described below with reference to accompanying drawings in the embodiments of the present application. Obviously, the described embodiments are only a part of the embodiments of the present application, but not all of the embodiments. Based on the embodiments of the present application, all other embodiments obtained by those skilled in the art without any creative efforts fall within the protection scope of the present application.

Where specific techniques or conditions are not specified in the examples, they may be carried out in accordance with the techniques or conditions described in the literature of this field or in accordance with the product instructions.

### First Embodiment

Please referring to FIG. 3 to FIG. 6, a replacement storefront door lock with no drilling 80 according to a first embodiment of the present application is configured to be mounted on a door panel 90, and configured to releasably lock an object to be locked (the object to be locked may be a fixed door frame or another movable door panel) relative to the door panel 90. It should be understood that the replacement storefront door lock with no drilling 80 may also be mounted at a fixed door frame, with the object to be locked being the door panel. In this embodiment, the replacement storefront door lock with no drilling 80 includes an outdoor component 11, an indoor component 13, a mortise 15, and a tailpiece 17. The outdoor component 11 is mounted at an outer side of the door panel 90 and includes a cylinder core 110. The indoor component 13 is mounted at an inner side of the door panel 90. The mortise 15 is located between the outdoor component 11 and the indoor component 13. Wherein the outer and inner sides of the door panel 90 are two sides opposite to each other. Generally, when the door panel 90 is in use, the side facing interior of a room is considered the inner side, and the side facing exterior of the room is considered the outer side. The mortise 15 includes a bolt 152, which is capable of extending outward from the door panel 90 or retracting into the door panel 90 to achieve locking or unlocking. One end of the tailpiece 17 is connected to the cylinder core 110 of the outdoor component 11, and the tailpiece 17 is rotatably arranged.

Specifically, the outdoor component 11 may further include a first external force drive component connected to the cylinder core 110 of the outdoor component 11 or one end of the tailpiece 17. The first external force drive component is configured to drive either the cylinder core 110 of the outdoor component 11 or the tailpiece 17. Rotation of the tailpiece 17 in a first direction causes the bolt 152 of the mortise 15 to move to extend; rotation of the tailpiece 17 in a second direction opposite to the first direction causes the bolt 152 of the mortise 15 to move to retract. Specifically, the first external force drive component may be a knob or a handle etc. sleeved on the cylinder core 110 of the outdoor component 11. In this embodiment, the first external force drive component includes a key 111 engaged with the cylinder core 110.

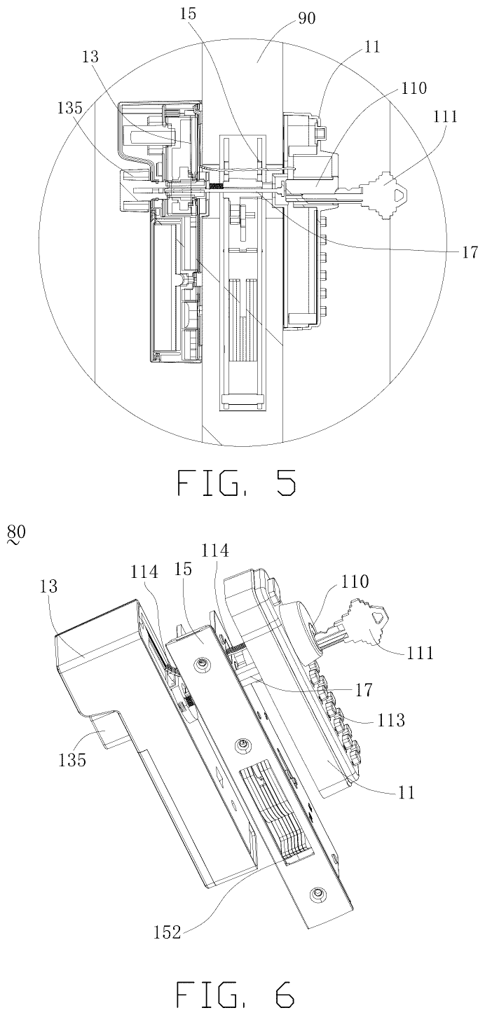

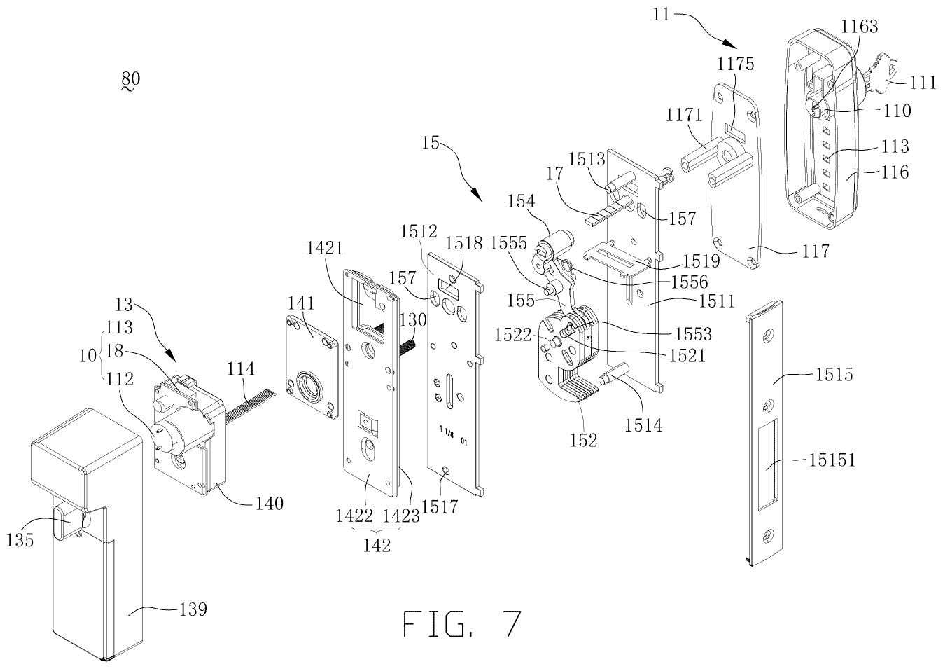

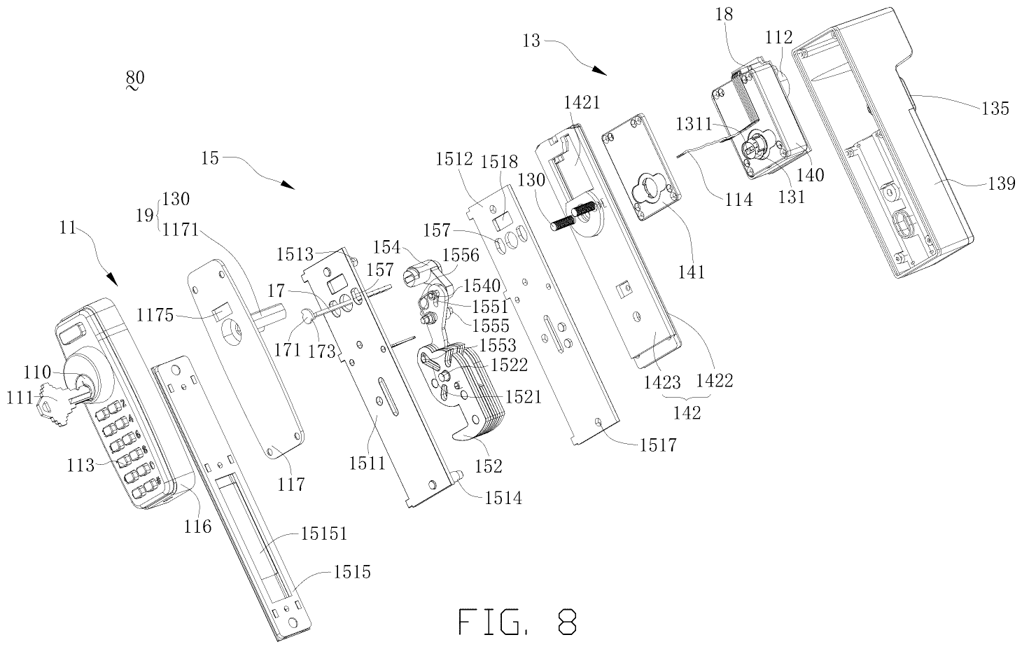

In this embodiment, a replacement storefront door lock with no drilling 80 further includes an electronic assembly 10. The electronic assembly 10 includes a main circuit board 18, a motor 112 (see FIG. 5 and FIG. 6) located in the indoor component 13 and a command-signal verification element 113 located on the outdoor component 11. Both the motor 112 and the command-signal verification element 113 are electrically connected to the main circuit board 18. When a verification signal input the verification command-signal verification element 113 is correct, the main circuit board 18 generates a control command and sends the control command to the motor 112 of the indoor component 13. When the motor 112 receives the control command, the motor 112 drives the tailpiece 17 to rotate, thereby causing the bolt 152 to extend or retract to open or lock the door. Wherein a conductor 114 (such as a conductive wire), which is connected to the main circuit board 18, passes through a wire hole 1518 in a housing 151 of the mortise 15 to transmit electronic signals. Specifically, the motor 112 is connected to the tailpiece 17. A user may insert a matching key 111 into a keyhole of the cylinder core 110 and rotate the key 111 to drive the cylinder core 110 to rotate, thereby causing the bolt 152 to extend or retract. Alternatively, the user may input a verification signal through the command-signal verification element 113. When the verification signal is correct, the motor 112 drives the tailpiece 17 to rotate, thereby causing the bolt 152 to retract. In this way, a keyless locking structure is achieved. That is to say, in this embodiment, the replacement storefront door lock with no drilling 80 is a smart electronic lock. It should be understood that the command-signal verification element 113 may include one or more of the following command-signal verification elements: a keypad, a fingerprint recognition unit, or a facial recognition unit, to receive variety of verification signals. When the command-signal verification element 113 is a keypad, the verification signal is a password. When the command-signal verification element 113 is a fingerprint recognition unit, the verification signal is fingerprint information.

In this embodiment, the electronic main board 18 and the motor 112 may be electrically connected via the conductor 114, and the electronic main board 18 and the command-signal verification element 113 may be electrically connected via the conductor 114. Specifically, in this embodiment, the electronic main board 18 is located on the indoor component 13, and the conductor 114 connecting the electronic main board 18 and the command-signal verification element 113 passes through the wire hole 1518 of the mortise 15. It should be understood that the electronic main board 18 may also be located on the outdoor component 11 (for example, on the inner side of a housing of the outdoor component 11), and the conductor 114 connecting the electronic main board 18 and the motor 112 passes through the wire hole 1518 of the mortise 15. Alternatively, the electronic main board 18 may also be located on the mortise 15. The electronic main board 18 is configured to determine whether the verification signal is correct according to the verification signal input to the command-signal verification element 113 (for example, password, facial information, or fingerprint information) and a pre-stored information in the electronic main board 18, and to control the motor 112 to work to drive the tailpiece 17 to rotate when the verification signal is correct, thereby causing the bolt 152 to retract to unlock the door.

In this embodiment, the electronic assembly 10 further includes a battery (not shown), and the battery is connected to the motor 112 and the command-signal verification element 113 to power the motor 112 and the command-signal verification element 113.

In this embodiment, please referring to FIG. 7 and FIG. 8, the outdoor component 11 includes an outer main housing 116 and an outer cover plate 117. The outer main housing 116 has an opening at one side facing the mortise 15, and the outer cover plate 117 covers the opening of the outer main housing 116. The cylinder core 110 is located in the outer main housing 116. A cylinder core retaining pin 1163 is formed on the cylinder core 110, and a first hole for the tailpiece 17 to pass through is defined in the outer cover plate 117. One end of the tailpiece 17 is provided with a base plate 171, which is provided with a notch 173, so that the base plate 171 is generally fan-shaped. The cylinder core retaining pin 1163 of the cylinder core 110 is configured to abut against two end surfaces of the notch 173 of the base plate 171. When the cylinder core 110 rotates, the cylinder core retaining pin 1163 on the cylinder core 110 pushes the base plate 171 to rotate, that is, it drives the entire tailpiece 17 to rotate. The outer cover plate 117 is located on the side of the outer main housing 116 facing the mortise 15.

Specifically, the outer cover plate 117 may be fixedly connected to the outer main housing 116 via at least one first fastener.

Specifically, the outer cover plate 117 is provided with a first through hole 1175 for the conductor 114 to pass through.

In this embodiment, the indoor component 13 does not have a lock cylinder. The tailpiece 17 on the outdoor component 11 passes through the mortise 15 and then is directly and detachably connected to the indoor component 13.

Specifically, the indoor component 13 may include a sleeve 131. After passing through the housing 151 of the mortise 15, the tailpiece 17 is directly and detachably connected to the sleeve 131 of the indoor component 13, thereby driving the tailpiece 17 to rotate. This design allows for convenient installation and disassembly. Specifically, the sleeve 131 is provided with an inserting hole 1311 having a cross-section corresponding to the tailpiece 17.

Certainly, in other embodiments, the indoor component 13 may be equipped with a lock cylinder that resists the tailpiece 17. The cylinder core 110 of the outdoor component 11 and the lock cylinder of the indoor component 13 may be a pin tumbler lock, a disc tumbler lock, a magnetic lock, a smart card lock or a fingerprint lock etc. The present application does not intend to limit a type of the cylinder core 110 and a type of the lock cylinder of the indoor component 13, as long as it can meet the usage requirements of the lock. It should be understood that, since the tailpiece 17 is directly connected to the outdoor component 11 and the indoor component 13, the outdoor component 11 and the indoor component 13 may be coordinated with each other and may have different type of lock cylinder. For example, the outdoor component 11 may be an ordinary mechanical lock structure, while the indoor component 13 may be electronic lock such as an electronic password lock or an electronic fingerprint lock. Such a configuration enhances the convenience of locking and unlocking the indoor component 13, achieving a keyless lock structure design or electronic lock gear-driven locking or unlocking, thereby better meeting the usage requirements for replacing locks on commercial aluminum alloy shop door frames.

Specifically, the indoor component 13 may further include a second external force drive component 135 connected to the lock cylinder of the indoor component 13 or the other end of the tailpiece 17. The second external force drive component 135 is configured to drive the tailpiece 17 (or the lock cylinder or the sleeve 131), thereby causing the tailpiece 17 to rotate in the first direction and consequently retracting the bolt 152. Specifically, the second external force drive component 135 may be a knob or a handle etc. sleeved on the lock cylinder of the indoor component 13 or the sleeve 131. The second external force drive component 135 is provided with an inserting hole having a cross-section corresponding to the tailpiece 17, enabling the second external force drive component 135 to drive the tailpiece 17 to rotate.

Specifically, the indoor component 13 includes an indoor transmission assembly (not shown). The motor 112 is transmissively connected to the sleeve 131 via the indoor transmission assembly. An output shaft of the motor 112 may be connected to an input end of the indoor transmission assembly, and the sleeve 131 may be connected to an output end of the indoor transmission assembly. When the motor 112 works, it drives the sleeve 131 to rotate via the indoor transmission assembly, thereby extending or retracting the bolt 152.

Specifically, the indoor component 13 further includes an inner main housing 139, an inner sub-housing 140, an inner sub-cover 141, and an inner cover 142. The inner sub-cover 141 covers an opening of the inner sub-housing 140. The inner sub-housing 140 and the inner sub-cover 141 are located inside the inner main housing 139, and the inner cover 142 covers an opening of the inner main housing 139. The inner cover 142 is located at one side of the inner main housing 139 facing the mortise 15. The indoor transmission assembly is located inside the inner sub-housing 140. The motor 112 is mounted outside the inner sub-housing 140, and the output shaft of the motor 112 extends into the inner sub-housing 140 to connect with the indoor transmission assembly. In this embodiment, the inner sub-housing 140 is a gear box to accommodate the indoor transmission assembly (such as gears), and the inner sub-cover 141 is a gear box cover to cover the gear box. Specifically, he inner cover plate 142 may include a main cover 1422 and a mounting plate 1423 (see FIG. 7 and FIG. 8) disposed at one side of the main cover 1422, and the mounting plate 1423 faces the outdoor component 13. The mounting plate 1423 is configured to fixed to the inner side of the door panel 90. It should be understood that, in other embodiment, the mounting plate 1423 may be omitted, and the main cover 1422 may instead be fixed directly to the inner side of the door panel 90.

Specifically, the inner cover plate 142 is provided with a second through hole 1421 for the conductor 114 to pass through. The conductor 114 may be made of a flexible conductive material to facilitate bending.

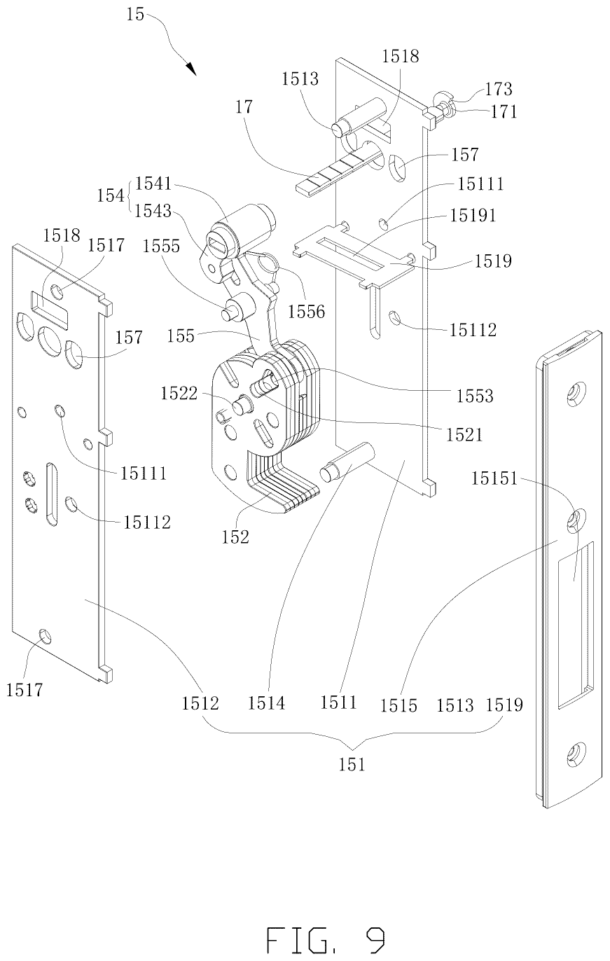

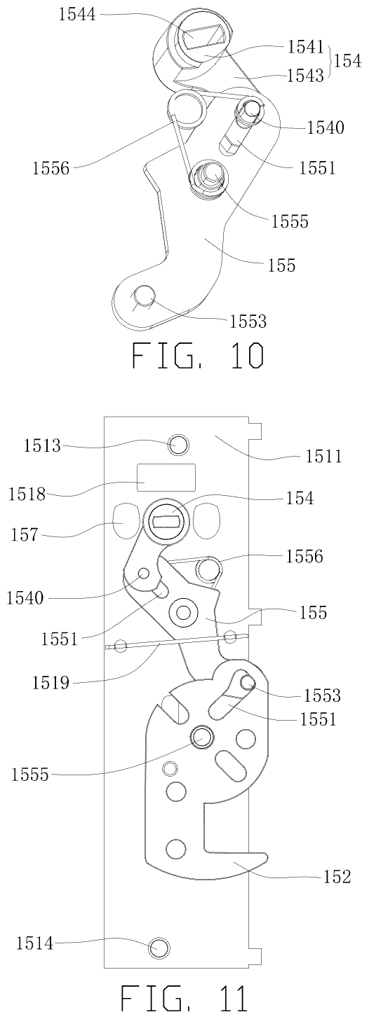

In this embodiment, please referring to FIG. 9 to FIG. 11, the mortise 15 includes a housing 151 fixedly mounted in the door panel 90 and the aforementioned bolt 152 movably disposed within the housing 151. When driven, the bolt 152 is capable of extending outward from the housing 151 or retracting into the housing 151 to achieve locking or unlocking. The housing 151 is mounted at an edge of the door panel 90. When the bolt 152 extends out of the housing 151, it also extends out of the door panel 90. When the bolt 152 retracts into the housing 151, it also retracts into the door panel 90. Specifically, in this embodiment, the bolt 152 may be hook-shaped. It should be understood that in other embodiments, the bolt 152 may be wedge-shaped or rectangular-shaped.

Specifically, the housing 151 includes a first side plate 1511, a second side plate 1512, a first connecting post 1513, a second connecting post 1514, and a front plate 1515. The first side plate 1511 and the second side plate 1512 are parallel and spaced apart. The first connecting post 1513 and the second connecting post 1514 are connected to the first side plate 1511 and the second side plate 1512 respectively to join them together. The front plate 1515 is located on the front side of the housing 151 and is configured to fixedly connected to the door panel 90. The first connecting post 1513 and the second connecting post 1514 may be disposed at two ends of the first side plate 1511 and the second side plate 1512 respectively. More specifically, snap holes 1517 are defined in the first side plate 1511 and the second side plate 1512. Ends of the first connecting post 1513 and the second connecting post 1514 are snapped into the snap holes 1517 to achieve the connection between the first side plate 1511, the second side plate 1512, the first connecting plate 1513, and the second connecting plate 1514. The front plate 1515 is provided with a bolt hole 15151 to allow the bolt 152 to extend therethrough.

Specifically, a wire hole 1518 is defined in each of the first side plate 1511 and the second side plate 1512 for allowing the conductor 114 to pass through.

Specifically, the housing 151 further includes a limiting plate 1519. Two ends of the limiting plate 1519 are connected to the first side plate 1511 and the second side plate 1512 respectively, and a limiting slot 15191 is defined in the limiting plate 1519.

Specifically, the first side plate 1511 and/or the second side plate 1512 are provided with a first rotating shaft hole 15111 and a second rotating shaft hole 15112.

In this embodiment, the mortise 15 further includes a drive shift 154 and a drive rod 155. The drive rod 155 is rotatably connected to the housing 151 around a first axis, and the bolt 152 is rotatably connected to the housing 151 around a second axis. The drive shift 154 is transmissively connected to the tailpiece 17 and is rotatably disposed relative to the housing 151 around a third axis to enable the drive shift 154 rotating driven by the tailpiece 17. An end of the drive rod 155 at one side of the first axis is movably connected to an end of the drive shift 154 far away from the third axis, and an end of the drive rod 155 at another side of the first axis is movably connected to the bolt 152. The drive shift 154 is configured to receive a driving force from either end of two ends of the tailpiece 17 to rotate. One side of the drive shift 154 protrudes to engage and drive the drive rod 155 to rotate around the first axis, thereby driving the bolt 152 to extend or retract to achieve locking or unlocking. Specifically, the drive rod 155 is rotatably connected to two sides of the housing 151. More specifically, the two ends of the drive rod 155 are rotatably connected to the first side plate 1511 and the second side plate 1512 of the housing 151 respectively. Driven by an external force or a key, the tailpiece 17 can rotate, which in turn drives the drive shift 154 to rotate and pushes the drive rod 155 to rotate in a certain angle, thereby pushing the bolt 152 to rotate. The drive shift 154 is configured to drive the bolt 152 to retract via the drive rod 155 when rotating around the first direction, and to drive the bolt 152 to extend through the drive rod 155 when rotating around a second direction opposite to the first direction. In the first embodiment, the tailpiece 17 is directly connected to the drive shift 154. In other embodiments, the tailpiece 17 may be indirectly connected to the drive shift 154. For example, gear teeth may be provided on an outer periphery of both the tailpiece 17 and the drive shift 154, and the tailpiece 17 and the drive shift 154 may be connected through meshed gears. Specifically, the drive rod 155 passes through the limiting slot 15191 of the limiting plate 1519, and a lateral movement of the drive rod 155 may be limited by the limiting slot 15191.

Specifically, in this embodiment, a first sliding post 1540 is formed at an end of the drive shift 154, which is away from the tailpiece 17. A first sliding groove 1551 is defined in a first side (i.e., a side adjacent to the tailpiece 17) of the drive rod 155, and a second sliding post 1553 is formed on a second side (i.e., a side adjacent to the bolt 152) of the drive rod 155. A first pivot shaft 1555 is formed connected to a middle portion (i.e., a position between the first side and the second side) of the drive rod 155. In this embodiment, the first pivot shaft 1555 passes through the drive rod 155 and is connected to the housing 151. The drive rod 155 is rotatably connected to the housing 151 via the first pivot shaft 1555. The first sliding post 1540 is movably extend into the first sliding groove 1551. A second sliding groove 1521 is defined in the bolt 152, and the second sliding post 1553 movably extends into the second sliding groove 1521. The bolt 152 is rotatably connected to the housing 151 via a second pivot shaft 1522.

Specifically, the mortise 15 further includes a torsion spring 1556 having a first free end, a second free end and a middle elastic portion disposed between the first free end the second free end. The first free end is sleeved on the first pivot shaft 1555 connected to the housing 151, and the second free end is sleeved on first sliding post 1540 of the drive shift 154. The torsion spring 1556 is configured to tactile feel during lock or unlock the replacement storefront door lock with no drilling. When an external force is provided on the first external force drive component or the second external force drive component to rotate the tailpiece 17 and the drive rod 155, the bolt 152 moves and overcomes an elastic force of the torsion spring 1556. Once the bolt 152 arrives at a critical value, the elastic force of the torsion spring 1556 drives the bolt 152 to move automatically.

Specifically, the drive shift 154 may include a sleeve tube 1541 and a rod 1543 connected to the sleeve tube 1541. The sleeve tube 1541 may have a coupling hole 1544 non-rotatably engaged with the tailpiece 17. The tailpiece 17 passes through the coupling hole 1544, and the sleeve tube 1541 is able to rotate together with the rotation of the tailpiece 17. The rod 1543 is configured to drive the bolt 152 to move with the rotation of the sleeve tube 1541. Furthermore, the rod 1543 protrudes from one side of an outer periphery of the sleeve tube 1541. The rod 1543 rotates within a certain range with the rotation of the drive shift 1541, to make the first sliding post 1540 in the first sliding groove 1551 to push the drive rod 155 to rotate around the first pivot shaft 1555. In this process, the first sliding post 1540 slides in the first sliding groove 1551, and the rotation of the drive rod 155 makes the second sliding post 1553 pushing the bolt 152 to rotate around the second pivot shaft 1522. Specifically, the rod 1543 may be connected to a circumferential side surface of the sleeve tube 1541. As an alternative embodiment, the rod 1543 may extend radially outward from an end surface of the sleeve tube 1541 and protrude from the side surface of the sleeve tube 1541. This can also achieve the rotation of the rod 1543 together with the sleeve tube 1541, thereby moving the bolt 152.

Preferably, a cross-sectional shape of the coupling hole 1544 corresponds to a cross-sectional shape of the tailpiece 17, that is, the coupling hole 1544 and the tailpiece 17 are matched in shape. The present application does not restrict the cross-sectional shapes of the coupling hole 1544 and the tailpiece 17. For example, the cross-sectional shapes of the coupling hole 1544 and the tailpiece 17 may be rectangular or square. Alternatively, the cross-sectional shapes of the coupling hole 1544 and the tailpiece 17 may be cross-shaped, etc. It should be understood that the coupling hole 1544 and the tailpiece 17 may also be non-shape-matched, so long as an inner wall of the sleeve tube 1541 has a limiting structure for limiting the clockwise and counterclockwise rotation of the tailpiece 17 to achieved a transmission connection between the tailpiece 17 and the sleeve tube 1541.

In this embodiment, the replacement storefront door lock with no drilling further includes an installation fixing component 19. A middle part of the installation fixing component 19 passes through an installation hole 157 of the mortise 15. Two ends of the installation fixing component 19 are fixedly connected to the outdoor component 11 and the indoor component 13 respectively.

Specifically, the installation and fixing component 19 may include a screw 130 formed on the indoor component 13. The screw 130 may have a threaded portion 1301 for connecting with the outdoor component 11. The threaded portion 1301 is configured to be screw-connected with the outdoor component 11 to achieve the positioning installation between the indoor component 13 and the outdoor component 11. External threads are formed on the threaded portion 1301.

As a first possible embodiment of the installation fixing component 19 in this application, the installation fixing component 19 may further include a mounting post 1171, one end of which is formed on the outdoor component 11. Another end of the mounting post 1171 may pass through the installation hole 157 of the mortise 15 and be screw-connected with the screw 130. The mounting post 1171 passes through the mortise 15 and is connected with the screw 130, which makes the installation more firmly and also avoids the damage to the outdoor component 11 in case the screw 130 is directly installed on the outdoor component 11. In this embodiment, the screw 130 passes through the mounting plate 1423 and the door panel 90 and threads into the mounting post 1171, thus fixing the mounting plate 1423 to the outdoor component 13 and the door panel 90.

As a second possible embodiment of the installation fixing component 19 in this application, the screw 130 on the indoor component 13 passes through the installation hole 157 of the mortise 15 and is screw-connected with a screw hole on the outdoor component 11 (At this time, the mounting post 1171 on the outdoor component 11 may be omitted, and a screw hole may be directly defined in the outdoor component 11). As such the outdoor component 11, the indoor component 13, and the mortise 15 are axially connected and fixed to the door panel 90. Certainly, in some other embodiments, the outdoor component 11 may also be provided with a mounting post 1171. Internal threads are defined in the mounting post 1171, and the screw 130 passes through the mortise 15 and is connected with the mounting post 1171. This arrangement prevents the outdoor component 11 from being damaged when the screw 130 is directly installed on the outdoor component 11.

It should be understood that the number of screws 130 and mounting posts 1171 are equal. The number of screws 130 and mounting posts 1171 is one each, and the number of installation holes 157 on the mortise 15 is one, which can reduce costs. Alternatively, several screws 130 and mounting posts 1171 in equal numbers may be provided. The installation holes 157 on the mortise 15 are correspondingly set for the screws 130 and mounting posts 1171 (the installation holes 157 on the mortise 15 are aligned with the screws 130 and mounting posts 1171 along the axis of the tailpiece 17), and the number of installation holes 157 on the mortise 15 is multiple. This not only facilitates the positioning of the outdoor component 11 and the indoor component 13 more conveniently, but also makes the connection between the outdoor component 11 and the indoor component 13 more secure.

When the user unlocks a door, a torque in the first direction may be applied to the tailpiece 17 via the key 111 (or in other embodiments, via a knob or a handle connected to the tailpiece 17 as the first external force drive component), the motor 112 or the second external force drive component 135. Under action of this torque in the first direction, the tailpiece 17 drives the drive shift 154 to rotate along the first direction to drive the drive rod 155 to rotate in the second direction. This action causes the bolt 152 to rotate to retract into the mortise 15, disengaging from the lock slot of the locked object, thereby unlocking the door panel 90 from the locked object.

When locking, a torque in the second direction may be applied to the tailpiece 17 via the key 111 (or in other embodiments, via a knob or a handle connected to the tailpiece 17 as the first external force drive component), the motor 112 or the second external force drive component 135. Under action of this torque in the second direction, the tailpiece 17 drives the drive shift 154 to rotate along the first direction to drive the drive rod 155 to rotate in the first direction. This action causes the bolt 152 to rotate in the second direction to drive the bolt 152 to extend out of the housing 151 of the mortise 15 to engage with the lock slot of the locked object, thereby locking the door panel 90 to the locked object.

In this embodiment, the conductor 114 passes through the mortise 15 from the indoor component 13 and extends into the outdoor component 11, and the conductor 114 is electrically connected to the command-signal verification element 113. Specifically, the command-signal verification element 113 is installed on the outer main housing 116, and both the motor 112 and the electronic main board 18 are installed in the inner sub-housing 140. The conductor 114 connected to the electronic main board 18 sequentially passes through the second through hole 1421 of the indoor component 13, the wire holes 1518 on the first side plate 1511 and the second side plate 1512 of the housing 151 of the mortise 15, the first through hole 1175 on the outer cover plate 117 of the outdoor component 11, and extends into the outer main housing 116. The conductor 114 is electrically connected to the command-signal verification element 113 installed on the outer main housing 116. In this way, the conductor 114 does not need to occupy additional space. More specifically, the wire hole 1518 is formed adjacent the drive shift 154 and offset from the drive shift 154. The two wire holes 1518 and the first through hole 1175 are substantially aligned, that is, the two wire holes 1518 and the first through hole 1175 are in a same line. The conductor 114 extends from a top, outer side of the inner sub-housing 140 and along an outer surface of the inner sub-cover plate 141, then passes through the second through hole 1421, and extends into the outer main housing 116 through the outer cover plate 117 to be electrically connected to the command-signal verification element 113 installed on the outer main housing 116.

### Second Embodiment

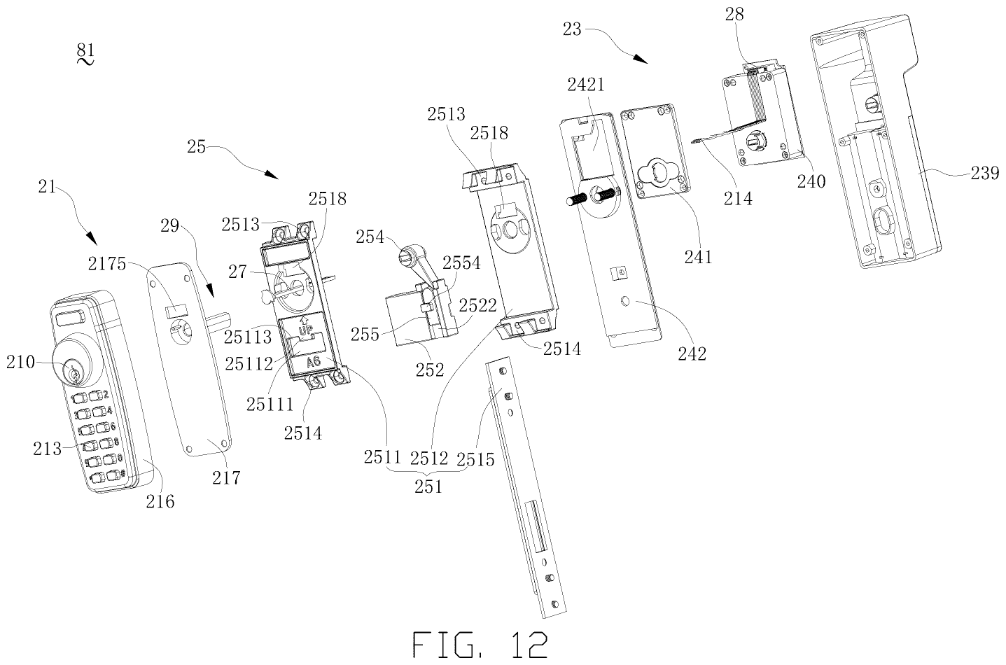

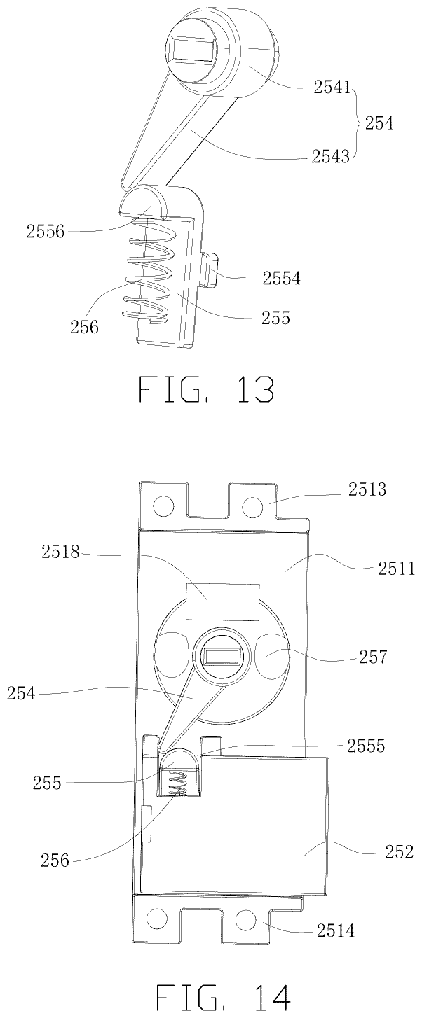

Similar to the replacement storefront door lock with no drilling 80 of the first embodiment, a replacement storefront door lock with no drilling 81 in the second embodiment of the present application is configured to be mounted at a door panel (not shown) or a door frame, and configured to releasably lock an object to be locked relative to the door panel. Referring to FIG. 12 to FIG. 14, the replacement storefront door lock with no drilling 81 includes an outdoor component 21, an indoor component 23, a mortise 25, and a tailpiece 27. The outdoor component 21 includes a cylinder core 210. The mortise 25 includes a bolt 252, and the bolt 252 may extend out of the door panel or retract into the door panel for locking or unlocking.

In this embodiment, the structure and interrelationship of the outdoor component 21, the indoor component 23, and the tailpiece 27 are similar to those of the outdoor component 11, the indoor component 13, and the tailpiece 17 in the first embodiment. The main difference between this embodiment and the first embodiment is that the structure of the mortise 25 is different from that of the mortise 15 in the first embodiment.

Specifically, the outdoor component 21 in this embodiment may further include a first external force drive member that is essentially the same as the first external force drive member in the first embodiment. The replacement storefront door lock with no drilling 81 further includes an electronic assembly. The electronic assembly includes an electronic main board 28, a motor 212 located on the indoor component 23, and a command-signal verification element 213 located on the outdoor component 21. The structure, connection, and function of the electronic main board 28, the motor 212, and the command-signal verification element 213 are essentially the same as those of the electronic main board 18, the motor 112, and the command-signal verification element 113 in the first embodiment, and will not be repeated here.

In this embodiment, the outdoor component 21 includes an outer main housing 216 and an outer cover plate 217. The outer cover plate 217 defines a first through hole 2175 for the conductor 214 to pass through, and the conductor 214 extends into an interior of the outer main housing 216 to electrically connected to the command-signal verification element 213 disposed on the outer main housing 216. The indoor component 23 further includes an inner main housing 239, an inner sub-housing 240, an inner sub-cover 241, and an inner cover 242. The inner cover plate 242 is provided with a second through hole 2421 for the conductor 214 to pass through. In this embodiment, the inner sub-housing 240 is a gear box to accommodate indoor transmission assembly (such as gears), and the inner sub-cover 241 is a gear box cover to cover the gear box. Specifically, the inner cover plate 242 may have a structure similar to the inner cover plate 142.

In this embodiment, the mortise 25 includes a housing 251 and the above-described bolt 252 movably disposed in the housing 251. When driven, the bolt 252 is capable of extending outward from the housing 251 or retracting into the housing 251 to achieve locking or unlocking. Specifically, the bolt 252 may be rectangular-shaped.

Specifically, the housing 251 includes a first side plate 2511, a second side plate 2512 and a front plate 2515. The first side plate 2511 and the second side plate 2512 are parallel and spaced apart. A first connecting block 2513 and a second connecting block 2514 are disposed at each end of two ends of each of the first side plate 2511 and the second side plate 1512. The first connecting block 2513 of the first side plate 2511 is fixedly connected to the second connecting block 2514 of the second side plate 2512 via a fastening member and the second connecting block 2514 of the first side plate 2511 is fixedly connected to the first connecting block 2513 of the second side plate 2512 via a fastening member, thus the first side plate 2511 and the second side plate 2512 are connected together. Specifically, a wire hole 2518 is defined in each of the first side plate 2511 and the second side plate 2512 for allowing the conductor 214 to pass through.

In this embodiment, the mortise 25 further includes a drive shift 254, a drive rod 255, and an elastic member 256. The elastic member 256 resists the drive rod 255 and the bolt 252 to push the drive rod 255 towards the drive shift 254. The drive shift 254 is movably set within the housing 251, and the bolt 252 is slidably disposed in the housing 251 for linear reciprocation. The drive rod 255 is movably in a direction perpendicular to the movement direction of the bolt 252. The drive shift 254 is configured to abut against the bolt 252 to drive the bolt 252 to move under push of the drive rod 255. The drive shift 254 is connected to the tailpiece 27 and is rotatably disposed in the mortise 25 to drive a movement of the drive rod 255 and the bolt 252, thereby causing the bolt 252 to extend or retract. The drive shift 254 is configured to receive a driving force from either end of the tailpiece 27 to rotate. A protrusion on one side of the drive shift 254 drives the bolt 252 to extend or retract, thereby achieving locking or opening. Under the drive of external force or a key, the tailpiece 27 can rotate to drive the drive shift 254 to rotate, thus causing the drive rod 255 to move up and down and causing the bolt 252 to move. The drive shift 254 is configured to drive the bolt 252 to retract when rotating in a first direction, and to drive the bolt 252 to extend when rotating in a second direction.

Specifically, in this embodiment, a driving slot 2522 is defined in the bolt 252, and a positioning slot 25111 is defined in the first side plate 2511. The positioning slot 25111 is generally “ [symbol] ”-shaped, that is, a protrusion 25112 is formed on a middle of a top portion of the positioning slot 25111, and a positioning sub-slot 25113 is defined on each side of the protrusion 25112. The drive rod 255 is movably disposed in the driving slot 2522 in the vertical direction, and a positioning block 2554 is formed on the drive rod 255 movably extending into the positioning slot 25111. A driving slot 2555 is defined in each of two sides of the drive rod 255 and the driving slot 2555 is located between the bolt 252 and the drive shift 255. One end of the drive shift 254 can swing between the two driving slots 2555 and can abut against either driving slot 2555. Specifically, when the tailpiece 27 rotates driven by an external force, the drive shift 254 rotates, and one end of the drive shift 254 swings from one of the two driving slots 2555 to the other of the two driving slots, thereby pushing the drive rod 255 to move downward and compress the elastic member 256. After entering the other driving slot 2555, the drive shift 254 continues to rotate to drive the bolt 252 to move. During this process, the positioning block 2554 on the drive rod 255 moves from one of the two positioning sub-slots 25113 to the other of the two positioning sub-slots 25113. As the drive rod 255 moves downward, the positioning block 2554 can move over the protrusion 25112 and into the other positioning slot 25113. As such, the bolt 252 can be locked. The drive rod 255 further has a resisting portion 2556 on the side in contact with the drive shift 254, and the resisting portion 2556 protrudes towards the drive shift 254. One end of the elastic member 256 resists the resisting portion 2556. Specifically, a surface of the resisting portion 2556 facing the drive shift 254 is a curved surface (specifically a cylindrical surface in this embodiment, but it can also be a spherical surface) to facilitate the drive shift 254 moving over the resisting portion 2556 during rotation.

The structure of the drive shift 254 in this embodiment is essentially the same as that of the drive shift 154 in the first embodiment, and will not be repeated here.

In this embodiment, the replacement storefront door lock with no drilling 81 further includes an installation fixing component 29. A structure and connection manner of the installation fixing component 29 is similar to that of the installation fixing component 19 of the first embodiment, and will not be repeated here.

When the user unlocks a door, a torque in the first direction may be applied to the tailpiece 27 via a key (or in other embodiments, via a knob or a handle connected to the tailpiece 27 as the first external force drive component), the motor 212 or a second external force drive component (not shown). Under action of this torque in the first direction, the tailpiece 27 drives the drive shift 254 to rotate along the first direction to drive the drive rod 255 to move downwards. This action causes the bolt 252 to move to retract into the mortise 25, disengaging from the lock slot of the locked object, thereby unlocking the door panel from the locked object.

When locking, when the first external force drive component or the second external force drive component drive the tailpiece 27 around the second direction opposite to the first direction, the drive shift 254 will rotate in the second direction to drive the drive rod 255 moving downwards. This action causes the bolt 252 to move to extend out of the housing 251 of the mortise 25 to engage with the lock slot of the locked object, thereby locking the door panel to the locked object.

### Third Embodiment

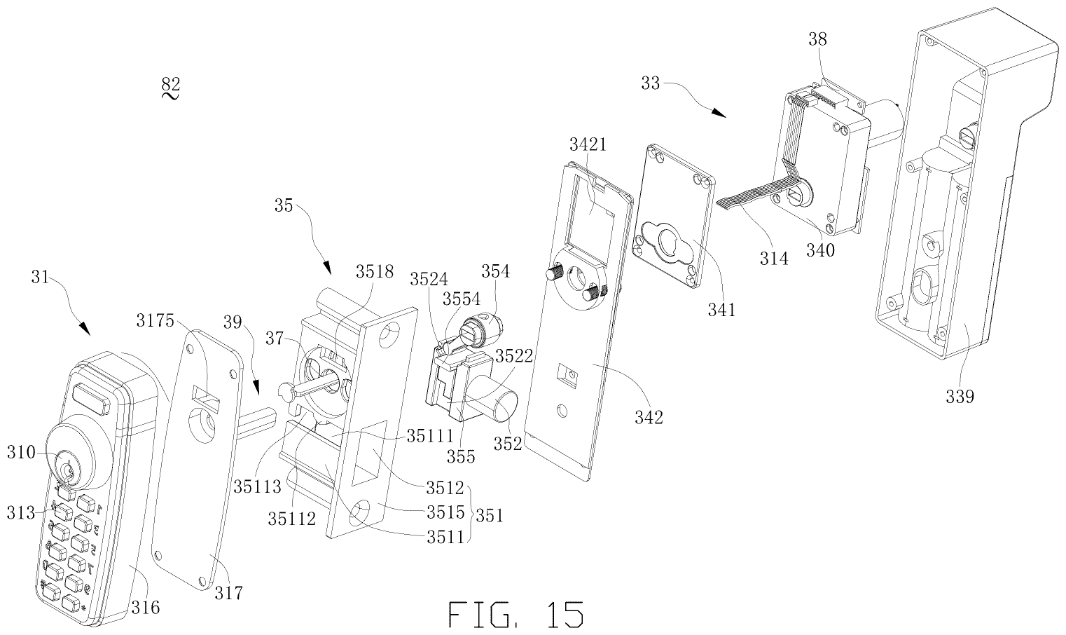

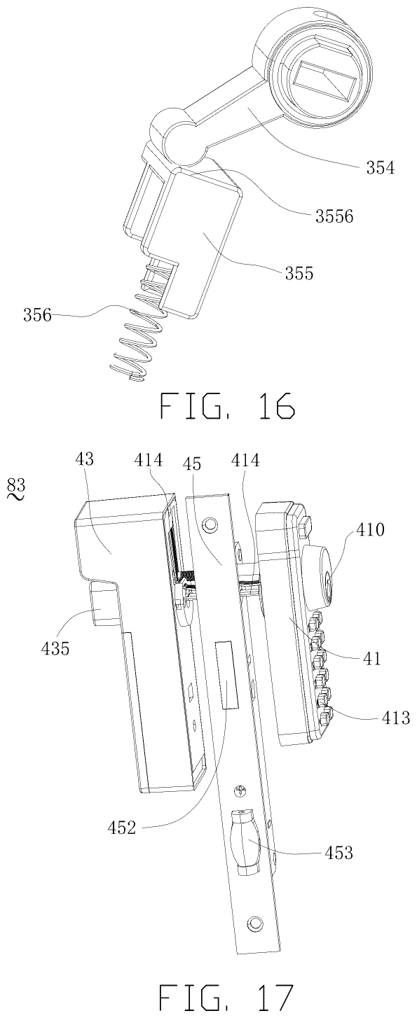

Similar to the replacement storefront door lock with no drilling 80 of the first embodiment, a replacement storefront door lock with no drilling 82 in the third embodiment of the present application is configured to be mounted at a door panel or a door frame, and configured to releasably lock an object to be locked relative to the door panel. Referring to FIG. 15 to FIG. 16, the replacement storefront door lock with no drilling 82 includes an outdoor component 31, an indoor component 33, a mortise 35, and a tailpiece 37. The outdoor component 31 includes a cylinder core 310. The mortise 35 includes a bolt 352, and the bolt 352 may extend out of the door panel or retract into the door panel for locking or unlocking.

In this embodiment, the structure and interrelationship of the outdoor component 31, the indoor component 33, and the tailpiece 37 are similar to those of the outdoor component 11, the indoor component 13, and the tailpiece 17 in the first embodiment. The main difference between this embodiment and the first embodiment is that the structure of the mortise 35 is different from that of the mortise 15 in the first embodiment.

Specifically, the outdoor component 31 in this embodiment may further include a first external force drive member that is essentially the same as the first external force drive member in the first embodiment. The replacement storefront door lock with no drilling 82 further includes an electronic assembly. The electronic assembly includes an electronic main board 38, a motor 312 located in the indoor component 33, and a command-signal verification element 313 located on the outdoor component 31. The structure, connection, and function of the electronic main board 38, the motor 312, and the command-signal verification element 313 are essentially the same as those of the electronic main board 18, the motor 112, and the command-signal verification element 113 in the first embodiment, and will not be repeated here.

In this embodiment, the outdoor component 31 includes an outer main housing 316 and an outer cover plate 317. The outer cover plate 317 defines a first through hole 3175 for the conductor 314 to pass through, and the conductor 314 extends into an interior of the outer main housing 316 to electrically connected to the command-signal verification element 313 disposed on the outer main housing 316. The indoor component 33 further includes an inner main housing 339, an inner sub-housing 340, an inner sub-cover 341, and an inner cover 342. The inner cover plate 342 is provided with a second through hole 3421 for the conductor 314 to pass through. In this embodiment, the inner sub-housing 340 is a gear box to accommodate indoor transmission assembly (such as gears), and the inner sub-cover 341 is a gear box cover to cover the gear box. Specifically, the inner cover plate 342 may have a structure similar to the inner cover plate 142.

In this embodiment, the mortise 35 includes a housing 351 and the above-described bolt 352 movably disposed in the housing 351. The bolt 352 is capable of extending outward from the housing 351 or retracting into the housing 351 to achieve locking or unlocking. Specifically, the bolt 352 may be cylindrical.

Specifically, the housing 351 includes a first side plate 3511, a second side plate 3512 and a front plate 3515. Structure of the first side plate 3511, the second side plate 3512 and the front plate 3515 are essentially the same as those of the first side plate 2511, the second side plate 2512 and the front plate 2515 in the second embodiment. The difference is that, in this embodiment, the housing 351 is an integrally formed monolithic structure, and the connecting members to connect the first side plate and the second side plate may be omitted. Specifically, a wire hole 3518 is defined in each of the first side plate 3511 and the second side plate 3512 for allowing the conductor 314 to pass through.

In this embodiment, the mortise 35 further includes a drive shift 354, a drive rod 355, and an elastic member 356. The structures and interrelationships of the drive shift 354, the drive rod 355, the elastic member 356, and the bolt 352 in this embodiment are basically similar to those of the drive shift 254, the drive rod 255, the elastic member 256, and bolt 252 in the second embodiment, and will not be described in detail again.

Specifically, in this embodiment, a driving slot 3522 is defined in the bolt 352, and a positioning slot 35111 is defined in the first side plate 3511. The positioning slot 35111 is generally “ [symbol] ”-shaped, that is, a protrusion 35112 is formed on a middle of a top portion of the positioning slot 35111, and a positioning sub-slot 35113 is defined on each side of the protrusion 35112. The drive rod 355 is movably disposed in the driving slot 3522 in vertical direction, and a positioning block 3554 is formed on the drive rod 355 movably extending into the positioning slot 35111. Two spaced resisting surfaces 3524 are defined on a side of the bolt 352 facing the drive shift 354. The two resisting surfaces 3524 are located on two sides of a top of the drive shift 355 respectively. One end of the drive shift 354 is movable between the two resisting surfaces 3524 and abuts against either one of the two resisting surfaces 3524. An end of the drive rod 355 that abuts against the drive shift 354 defines an resisting portion 3556, and the resisting portion 3556 protrudes towards a side of the drive shift 354, and one end of the elastic member 356 abuts against the resisting portion 3556. Specifically, a surface of the resisting portion 3556 facing the drive shift 354 may be a flat surface.

The structure of the drive shift 354 in this embodiment is essentially the same as that of the drive shift 154 in the first embodiment, and will not be repeated here.

In this embodiment, the replacement storefront door lock with no drilling 82 further includes an installation fixing component 39. A structure and connection manner of the installation fixing component 39 is similar to that of the installation fixing component 19 of the first embodiment, and will not be repeated here.

In this embodiment, the process of locking and unlocking through the first external driving member or the second external driving member (not shown in the FIGS) on the internal component 33 is the same as that in the second embodiment, and will not be described in detail again.

### Fourth Embodiment

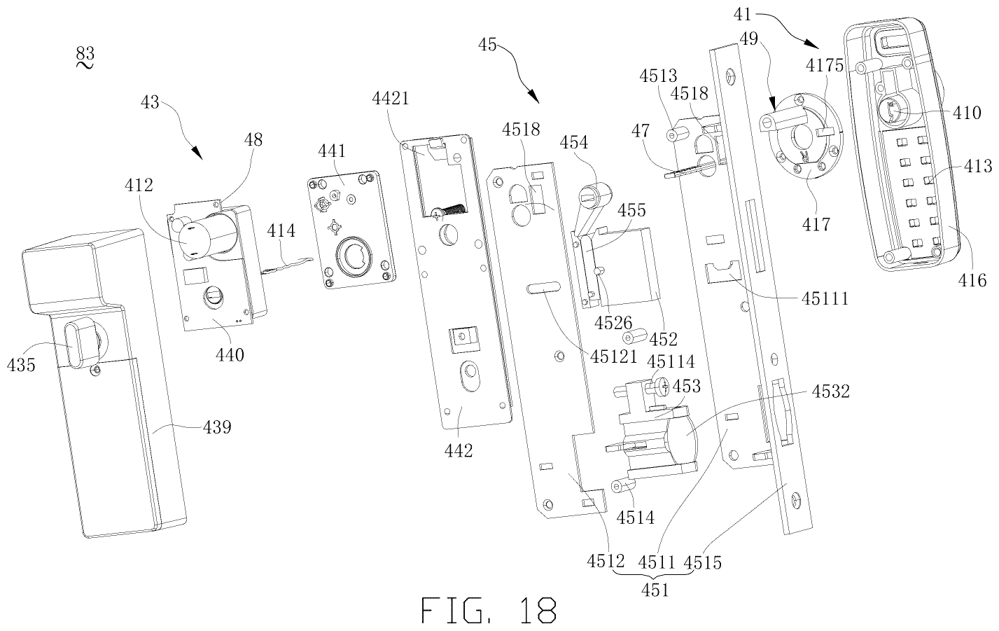

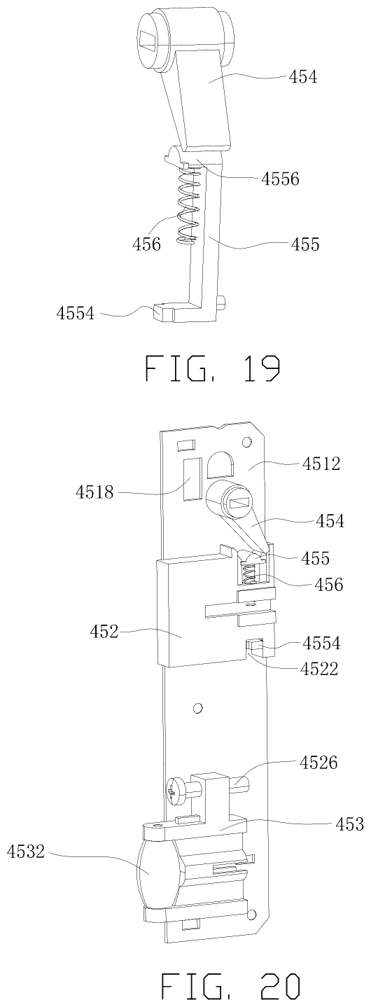

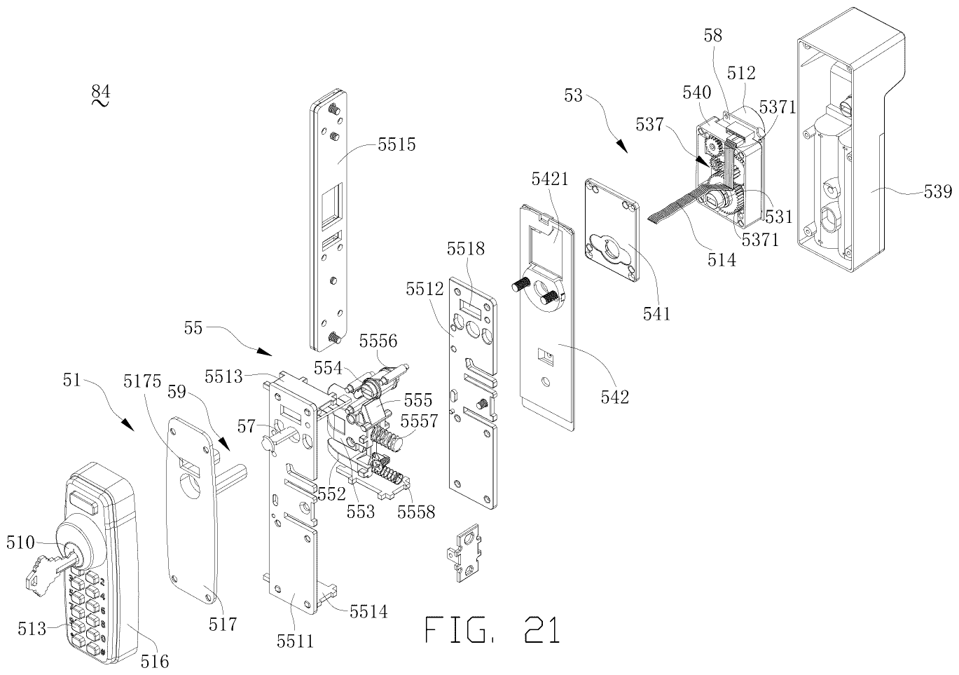

Similar to the replacement storefront door lock with no drilling 80 of the first embodiment, a replacement storefront door lock with no drilling 83 in the fourth embodiment of the present application is configured to be mounted at a door panel, and configured to releasably lock an object to be locked relative to the door panel. Referring to FIG. 17 to FIG. 20, the replacement storefront door lock with no drilling 83 includes an outdoor component 41, an indoor component 43, a mortise 45, and a tailpiece 47. The outdoor component 41 includes a cylinder core 410. The mortise 45 includes a bolt 452, and the bolt 452 may extend out of the door panel or retract into the door panel for locking or unlocking.

In this embodiment, the structure and interrelationship of the outdoor component 41, the indoor component 43, and the tailpiece 47 are similar to those of the outdoor component 11, the indoor component 13, and the tailpiece 17 in the first embodiment. The main difference between this embodiment and the first embodiment is that the structure of the mortise 45 is different from that of the mortise 15 in the first embodiment.

Specifically, the outdoor component 41 in this embodiment may further include a first external force drive member that is essentially the same as the first external force drive member in the first embodiment. The replacement storefront door lock with no drilling 83 further includes an electronic assembly. The electronic assembly includes an electronic main board 48, a motor 412 located in the indoor component 43, and a command-signal verification element 413 located on the outdoor component 41. The structure, connection, and function of the electronic main board 48, the motor 412, and the command-signal verification element 413 are essentially the same as those of the electronic main board 18, the motor 112, and the command-signal verification element 113 in the first embodiment, and will not be repeated here.

In this embodiment, the outdoor component 41 includes an outer main housing 416 and an outer cover plate 417. The outer cover plate 417 defines a first hole for the tailpiece 47 to pass through. The outer cover plate 417 defines a first through hole 4175 for the conductor 414 to pass through, and the conductor 414 extends into an interior of the outer main housing 416 to electrically connected to the command-signal verification element 413 disposed on the outer main housing 416. The indoor component 43 further includes an inner main housing 439, an inner sub-housing 440, an inner sub-cover 441, and an inner cover 442. The inner cover plate 442 is provided with a second through hole 4421 for the conductor 414 to pass through. The conductor 414 extends from a top outer side of the inner sub-housing 440 and extends along an outer surface of the inner sub-cover 441 and then passes through the second through hole 4421. In this embodiment, the inner sub-housing 440 is a gear box to accommodate indoor transmission assembly (such as gears), and the inner sub-cover 441 is a gear box cover to cover the gear box. Specifically, the inner cover plate 442 may have a structure similar to the inner cover plate 142.

In this embodiment, the mortise 45 includes a housing 451 and the above-described bolt 452 movably disposed in the housing 451. When driven, the bolt 452 is capable of extending outward from the housing 451 or retracting into the housing 451 to achieve locking or unlocking. Specifically, the bolt 452 may be cylindrical.

Specifically, the housing 451 includes a first side plate 4511, a second side plate 4512, a first connecting post 4513, a second connecting post 4514 and a front plate 4515. Structure of the first side plate 4511, the second side plate 4512, the first connecting post 4513, a second connecting post 4514 and the front plate 4515 are essentially the same as those of the first side plate 1511, the second side plate 1512, the first connecting post 1513, the second connecting post 1514 and the front plate 1515 in the first embodiment, and will not be repeated here. Specifically, a wire hole 4518 is defined in each of the first side plate 4511 and the second side plate 4512 for allowing the conductor 414 to pass through.

In this embodiment, the mortise 45 further includes a drive shift 454, a drive rod 455, and an elastic member 456. The structures and interrelationships of the drive shift 454, the drive rod 455, the elastic member 456, and the bolt 452 in this embodiment are basically similar to those of the drive shift 354, the drive rod 355, the elastic member 356, and bolt 352 in the third embodiment. The difference between the drive rod 455 in this embodiment and the drive rod 355 in the third embodiment mainly lies in that, in this embodiment, the surface of the resisting portion 4556 of the drive rod 455 facing the drive shift 454 is a curved surface (such as a cylindrical surface, a spherical surface, etc.). The difference between the bolt 452 in this embodiment and the bolt 352 in the third embodiment mainly lies in that the bolt 452 is further provided with a sliding post 4526, the second side plate 4512 is provided with a guide slot 45121 extending in the direction of extension and retraction of the bolt 452, and the sliding post 4526 movably extends into the guide slot 45121; furthermore, in this embodiment, after movably extending in a positioning slot 45111 passes through a driving slot 4522 of the bolt 452, a positioning block 4554 engages with the positioning slot 45111. The positioning slot 45111 is essentially the same as the positioning slot 25111 in the second embodiment.

The structure of the drive shift 454 in this embodiment is essentially the same as that of the drive shift 154 in the first embodiment, and will not be repeated here.

In this embodiment, the mortise 45 further includes an auxiliary bolt 453 movably disposed inside the housing 451. The auxiliary bolt 453 can extend out of or retract into the housing 451 when driven to achieve locking or unlocking. The housing 451 is installed at the edge of the door panel. When the auxiliary bolt 453 extends out of the housing 451, it also extends out of the door panel. When the auxiliary bolt 453 retracts into the housing 451, it also retracts into the door panel. Specifically, a guide rod 45114 is formed on the housing 451, and the auxiliary bolt 453 is movably mounted on the guide rod 45114. One end of the auxiliary bolt 453, which can extend out of the housing 451, is provided with a rolling ball 4532. The rolling ball 4532 can be cylindrical, spherical, or conical, etc. It should be understood that the auxiliary bolt 453 may be omitted, and the door panel may be locked by relying only on the bolt 452.

In this embodiment, the replacement storefront door lock with no drilling 83 further includes an installation fixing component 49. A structure and connection manner of the installation fixing component 49 is similar to that of the installation fixing component 19 of the first embodiment, and will not be repeated here.

In this embodiment, the process of locking and unlocking through the first external driving member or the second external driving member 435 is the same as that in the second embodiment, and will not be described in detail again.

### Fifth Embodiment

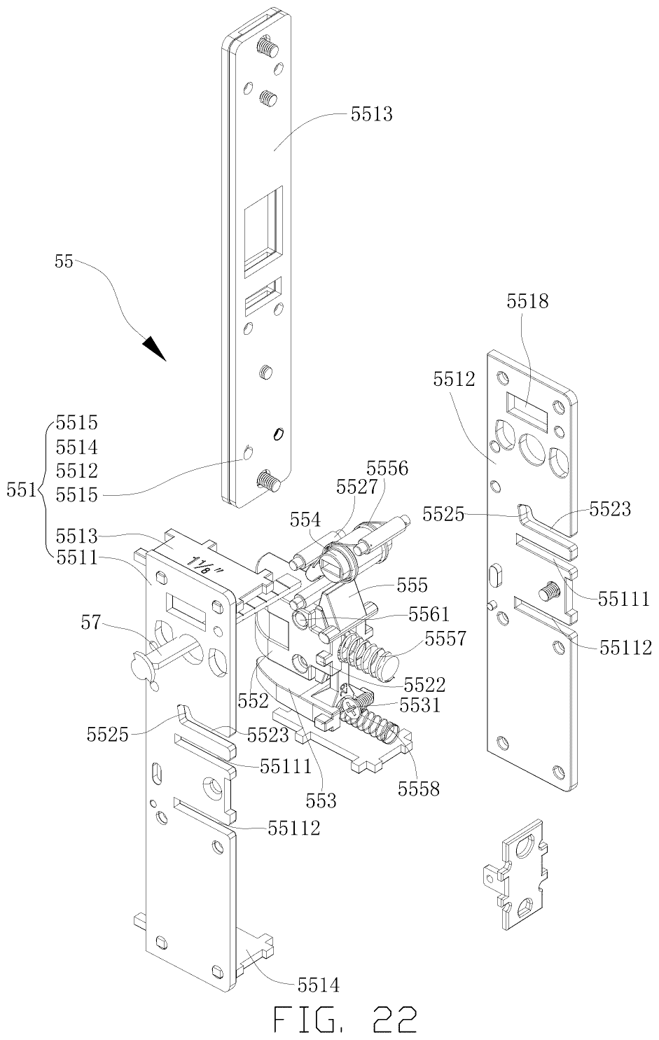

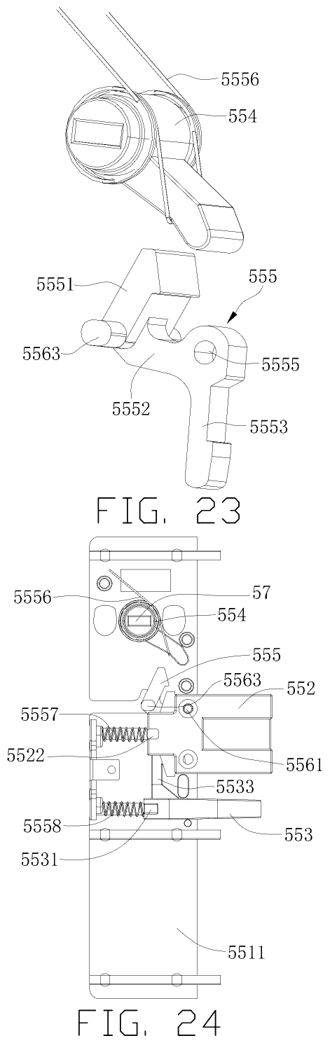

Similar to the replacement storefront door lock with no drilling 80 of the first embodiment, a replacement storefront door lock with no drilling 84 in the fifth embodiment of the present application is configured to be mounted at a door panel or a door frame, and configured to releasably lock an object to be locked relative to the door panel. Referring to FIG. 21 to FIG. 24, the replacement storefront door lock with no drilling 84 includes an outdoor component 51, an indoor component 53, a mortise 55, and a tailpiece 57. The outdoor component 51 includes a cylinder core 510. The mortise 55 includes a bolt 552, and the bolt 552 may extend out of the door panel or retract into the door panel for locking or unlocking.

In this embodiment, the structure and interrelationship of the outdoor component 51, the indoor component 53, and the tailpiece 57 are similar to those of the outdoor component 11, the indoor component 13, and the tailpiece 17 in the first embodiment. The main difference between this embodiment and the first embodiment is that the structure of the mortise 55 is different from that of the mortise 15 in the first embodiment.

Specifically, the outdoor component 51 in this embodiment may further include a first external force drive member that is essentially the same as the first external force drive member in the first embodiment. The replacement storefront door lock with no drilling 84 further includes an electronic assembly. The electronic assembly includes an electronic main board 58, a motor 512 located in the indoor component 53, and a command-signal verification element 513 located on the outdoor component 51. The structure, connection, and function of the electronic main board 58, the motor 512, and the command-signal verification element 513 are essentially the same as those of the electronic main board 18, the motor 112, and the command-signal verification element 113 in the first embodiment, and will not be repeated here.

In this embodiment, the outdoor component 51 includes an outer main housing 516 and an outer cover plate 517. The outer cover plate 517 defines a first through hole 5175 for the conductor 514 to pass through, and the conductor 514 extends into an interior of the outer main housing 516 to electrically connected to the command-signal verification element 513 disposed on the outer main housing 516. The indoor component 53 further includes an inner main housing 539, an inner sub-housing 540, an inner sub-cover 541, and an inner cover 542. The inner cover plate 542 is provided with a second through hole 5421 for the conductor 514 to pass through. In this embodiment, the inner sub-housing 540 is a gear box to accommodate indoor transmission assembly (such as gears), and the inner sub-cover 541 is a gear box cover to cover the gear box. Specifically, the inner cover plate 542 may have a structure similar to the inner cover plate 142.

Specifically, the indoor component 53 may include a sleeve 531. After passing through the housing 551 of the mortise 55, the tailpiece 57 is directly and detachably connected to the sleeve 531 of the indoor component 53. The sleeve 531 is provided with an inserting hole 5311 having a cross-section corresponding to the tailpiece 57. In this embodiment, the indoor component 53 may further include a second external force drive component 535 connected to the lock cylinder or the sleeve 531 of the indoor component 33 or the other end of the tailpiece 57.

Specifically, the indoor component 53 includes an indoor transmission assembly 537. The motor 512 is transmissibly connected to the sleeve 531 via the indoor transmission assembly 537. An output shaft of the motor 512 may be connected to an input end of the indoor transmission assembly 537, and the sleeve 531 may be connected to an output end of the indoor transmission assembly 537. Specifically, the indoor transmission assembly 537 may include a plurality of gears 5371. It should be understood that the indoor transmission assembly 537 may also be composed of other transmission structures such as a worm gear and a worm wheel.

In this embodiment, the mortise 55 includes a housing 551 and the above-described bolt 552 movably disposed in the housing 551. When driven, the bolt 552 is capable of extending outward from the housing 551 or retracting into the housing 551 to achieve locking or unlocking. Specifically, the bolt 552 may be wedge-shaped.

In this embodiment, the mortise 55 further includes an auxiliary bolt 553 movably disposed inside the housing 551. The auxiliary bolt 553 can extend out of or retract into the housing 551 when driven to achieve locking or unlocking. The housing 551 is installed at the edge of the door panel. When the auxiliary bolt 553 extends out of the housing 551, it also extends out of the door panel. When the auxiliary bolt 553 retracts into the housing 551, it also retracts into the door panel. The auxiliary bolt 553 may be wedge-shaped. It should be understood that the auxiliary bolt 553 may be omitted, and the door panel may be locked by relying only on the bolt 552.

Specifically, the housing 551 includes a first side plate 5511, a second side plate 5512, a first connecting plate 5513, a second connecting plate 5514 and a front plate 5515. The first side plate 5511 and the second side plate 5512 are parallel and spaced apart. The first connecting plate 5513 and the second connecting plate 5514 are connected to the first side plate 5511 and the second side plate 5512 respectively to join them together. The front plate 5515 is located on the front side of the housing 551 and is configured to fixedly connected to the door panel. The first connecting plate 5513 and the second connecting plate 5514 may be disposed at two ends of the first side plate 5511 and the second side plate 5512 respectively. Specifically, a wire hole 5518 is defined in each of the first side plate 5511 and the second side plate 5512 for allowing the conductor 514 to pass through.

Specifically, the first side plate 5511 and/or the second side plate 5512 are provided with a first limiting groove 55111 and a second limiting groove 55112 extending along a direction of movement of the deadlatch 552. The first side plate 5511 and/or the second side plate 5512 are further provided with a guiding groove 55113.

In this embodiment, the mortise 55 further includes a drive shift 554 and a drive rod 555. The tailpiece 57 is movably disposed within the housing 551. The drive shift 554 is connected to the tailpiece 57 and is rotatably mounted inside the mortise 55 to drive the drive rod 555 to slide, thereby moving the deadlatch 552 and the auxiliary bolt 553. The drive shift 554 is configured to receive a driving force from either end of two ends of the tailpiece 57 to rotate. One side of the drive shift 554 protrudes to engage and drive the drive rod 555, thereby retracting the deadlatch 552 to achieve unlocking. Specifically, the drive shift 554 is rotatably connected to two sides of the housing 551. More specifically, the two ends of the drive shift 554 are rotatably connected to the first side plate 5511 and the second side plate 5512 of the housing 551 respectively. Driven by an external force or a key, the tailpiece 57 can rotate, which in turn drives the drive shift 554 to rotate and move the drive rod 555, thereby moving the deadlatch 552 and the auxiliary bolt 553. The drive shift 554 is configured to drive the deadlatch 552 and the auxiliary bolt 553 to retract through the drive rod 555 when rotating around the first direction. Specifically, in this embodiment, the drive shift 554 and the drive rod 555 are separately disposed. The drive rod 555 may be located on the rotation path of the drive shift 554. In this way, when the drive shift 554 rotates to a position where it contacts the drive rod 555 and continues to rotate, it can drive the drive rod 555 to move. In the first embodiment, the tailpiece 57 is directly connected to the drive shift 554. In other embodiments, the tailpiece 57 may be indirectly connected to the drive shift 554. For example, gear teeth may be provided on an outer periphery of both the tailpiece 57 and the drive shift 554, and the tailpiece 57 and the drive shift 554 may be connected through meshed gears.

Specifically, the mortise 55 further includes a first reset component 5556 mounted on the drive shift 554. The first reset component 5556 is configured to provide a restoring force that drives the drive shift 554 to rotate along a second direction opposite to the first direction, thereby causing the tailpiece 57 to rotate in the second direction and separating the drive shift 554 from the drive rod 555. When the driving force on the tailpiece 57 is removed, the first reset component 5556 mounted on the drive shift 554 drives the drive shift 554 to reset along the second direction. Specifically, the first reset component 5556 may be an elastic element, such as a torsion spring. One end of the torsion spring is fixed relative to the drive shift 554, and the other end is fixed relative to the housing 551. The first reset component 5556 is pre-tensioned after installation. The housing 551 is further provided with a fixing post 5527, one end of the first reset component 5556 is fixed to the drive shift 554, and the other end is fixed to the fixing post 5527.

Specifically, the mortise 55 further includes a second reset component 5557 and a third reset component 5558. The second reset component 5557 is configured to provide a restoring force that extends the deadlatch 552 outward from the mortise 55, and the third reset component 5558 is configured to provide a restoring force that extends the auxiliary bolt 553 outward from the mortise 15. When the driving force on the tailpiece 57 is removed, the deadlatch 552 extends and resets under the action of the second reset component 5557 connected to the deadlatch 552, and the auxiliary bolt 553 extends and resets under the action of the third reset component 5558 connected to the auxiliary bolt 553. The second reset component 5557 is configured to drive the deadlatch 552 to move and extend out of the housing 551 of the mortise 55, and the third reset component 5558 is configured to drive the auxiliary bolt 553 to extend out of the housing 551 of the mortise 55. Specifically, the second reset component 5557 and the third reset component 5558 may be elastic elements, such as extension springs. Certainly, the second reset component 5557 and the third reset component 5558 may also be electromagnets that generate magnetic force to extend the deadlatch 552 when electrified. The second reset component 5557 and the third reset component 5558 are pre-compressed after installation. When the second reset component 5557 and the third reset component 5558 are provided, the extension of the deadlatch 552 and the auxiliary bolt 553 does not require the assistance of the second external force drive component 535 of the indoor component 53 and the first external force drive component of the outdoor component 51. When the external force acting on the deadlatch 552 and the auxiliary bolt 553 is removed (that is, the first external force drive component and the second external force drive component 535 are released to remove the force on the tailpiece 57), the restoring force of the second reset component 5557 and the third reset component 5558 can automatically drive the deadlatch 552 and the auxiliary bolt 553 to extend out of the housing 551 of the mortise 55.

Specifically, a first limiting block 5522 is formed on the deadlatch 552 to movably positioned within the first limiting groove 55111, and a second limiting block 5531 is formed on the auxiliary bolt 553 to movably positioned within the second limiting groove 55112. As such, extension lengths (i.e., stroke) of the deadlatch 552 and the auxiliary bolt 553 can be defined. By defining positions of the first limiting groove 55111 and the second limiting groove 55112, it is very easy to define the stroke of the deadlatch 552 and the auxiliary bolt 553 to meet the dimensional requirements when replacing the old lock. Also, the first limiting groove 55111 and the second limiting groove 55112 may also serve as guide grooves to guide the movement of the deadlatch 552 and the auxiliary bolt 553.

The structure of the drive shift 554 in this embodiment is essentially the same as that of the drive shift 154 in the first embodiment, and will not be repeated here.

Specifically, the drive rod 555 includes a first part 5551, a second part 5552 and a third part 5553. Two ends of the second part 5552 are connected to the first part 5551 and the third part 5553 respectively. The first part 5551 is oriented towards the drive shift 554, and the third part 5553 is oriented towards the auxiliary bolt 553. The drive rod 555 is further connected to the deadlatch 552. More specifically, the first part 5551 and the third part 5553 extend towards two sides of the second part 5552 respectively, and a certain angle is defined between the second part 5552 and each of the first part 5551 and the third part 5553. A shaft hole 5555 is further defined in the drive rod 555, and the drive rod 555 is rotatably connected to the deadlatch via a connecting shaft 5561 inserted into the shaft hole 5555. A protrusion 5563 movably accommodated within the guide groove 5523 of the housing 551 is further formed on the drive rod 555. A recess 5525 concave towards the drive shift 554 is defined in one end of the guide groove 5523, and the drive rod 555 can rotate around the connecting shaft 5561 relative to the deadlatch 552. When the deadlatch 552 is in the extended position, at least a part of the protrusion 5563 is capable of being located within the recess 5525. More specifically, the shaft hole 5555 may be defined at the connecting position between the second part 5552 and the third part 5553, and the protrusion 5563 may be provided at the connecting between the first part 5551 and the second part 5552.

Specifically, one side of the auxiliary bolt 553 is provided with an extension portion 5533, which corresponds to the third part 5553. When the drive rod 555 moves to left, the extension portion 5533 comes into contact with the third part 5553, thereby being moved by the drive rod 555.

In this embodiment, the replacement storefront door lock with no drilling 84 further includes an installation fixing component 59. A structure and connection manner of the installation fixing component 59 is similar to that of the installation fixing component 19 of the first embodiment, and will not be repeated here.

In this embodiment, the process of locking and unlocking through the first external driving member or the second external driving member 535 is the same as that in the second embodiment, and will not be described in detail again.

When the user unlocks a door via the outdoor component 51 or the indoor component 53, a first torque in the first direction may be applied to the tailpiece 57 via the key 511 (or in other embodiments, via a knob or a handle connected to the tailpiece 57 as the first external force drive component), the motor 512 (i.e., via an electronic password) or the second external force drive component 535 of the indoor component 53. Under action of this torque in the first direction, the tailpiece 57 drives the drive shift 554 to rotate along the first direction to drive the drive rod 555 to move in a third direction. This action causes the deadlatch 552 to retract into the mortise 55, disengaging from the lock slot of the locked object, thereby unlocking the door panel from the locked object.

During locking, when the first external force drive component or the second external force drive component 535 revokes the drive of the tailpiece 57 along the first direction, the drive shift 554 will rotate in the second direction opposite to the first direction and reset under the action of the first reset component 5556, and disengage from the drive rod 555. The restoring forces of the second reset component 5557 and the third reset component 5558 push the deadlatch 552 and the auxiliary bolt 553 to extend out of the housing 551 of the mortise 55 respectively to engage with the lock slot of the locked object, thereby locking the door panel to the locked object.

In the first embodiment to the fifth embodiment described above, the arrangement of the drive shift coupled with the mortise, makes it being convenient to design the relative position between the lock hole and the extended position of the bolt, as well as the overall size of the mortise. Moreover, it is easy to find a center point, torque, and rotation angle with a high degree of consistency with the old lock. Therefore, it is convenient to replace the old lock without the need to drill new holes in the door. Meanwhile, through the arrangement of conductor, the store door may be equipped with a smart lock without drilling holes to replace the old lock. The lock can be opened by means of a password, fingerprint, or facial recognition, achieving keyless locking and unlocking, which greatly enhances the convenience of using the lock.

The above only discloses some of the embodiments of the present disclosure and does not intend to limit the invention. Any modification, equivalents or improvement made within the spirit and principle of the disclosure shall be included in the scope of protection of the invention.

What is claimed is:

1. A replacement storefront door lock with no drilling, configured to be mounted on a first component of a storefront door so as to lock or unlock the first component relative to a second component, the replacement storefront door lock with no drilling comprising:
an outdoor component configured to mounted at an outer side of the first component, a command-signal verification element located on the outdoor component;
an indoor component configured to mounted at an inner side of the first component;
a mortise, disposed between the outdoor component and the indoor component, the mortise comprising a housing, a bolt and a drive shift, the bolt movably disposed in the housing, and the housing defining a wire hole;
a tailpiece, rotatably disposed and engaged with the drive shift, the drive shift configured to receive a driving from the tailpiece to rotate to push the bolt to extend or retract; and
an electronic assembly, comprising a main circuit board, a motor located in the indoor component and the command-signal verification element located on the outdoor component, the motor and the command-signal verification element electrically connected to the main circuit board, and when a verification signal sent by command-signal verification element verified by the main circuit board, the main circuit board sending a command to the motor in the indoor component, and the motor configured to drive the tailpiece to rotate, thereby causing the bolt to extend or retract to open or lock the door;
wherein a conductor connected to the main circuit board passes through the wire hole of the housing to transmit electronic signals.

2. The replacement storefront door lock with no drilling of claim 1, wherein the main circuit board is disposed on the indoor component, the conductor connected between the main circuit board and the command-signal verification element passes through the wire hole of the mortise.

3. The replacement storefront door lock with no drilling of claim 1, wherein the main circuit board is disposed in the outdoor component, the conductor connected between the main circuit board and the motor passes through the wire hole of the mortise.

4. The replacement storefront door lock with no drilling of claim 1, wherein the housing comprises a first side plate, a second side plate parallel to and spaced apart from the first side plate, and a front plate located at the front side of the housing, and each of the first side plate and the second side plate defines the wire hole.

5. The replacement storefront door lock with no drilling of claim 4, wherein the outdoor component comprises an outer main housing and an outer cover plate, the outer main housing has an opening on one side facing the mortise, and the outer cover plate covers the opening of the outer main housing, the outer cover plate is provided with a first through hole, and the command-signal verification element is disposed on the outer main housing; the indoor component further comprises an inner main housing, an inner sub-housing, an inner sub-cover, and an inner cover, the inner sub-cover covers an opening of the inner sub-housing, the inner sub-housing and the inner sub-cover are located inside the inner main housing, and the inner cover covers an opening of the inner main housing, the inner sub-cover is disposed at one side of the inner main housing facing the mortise, the motor is disposed on the inner sub-cover, the inner cover plate is provided with a second through hole, and the motor and the main circuit board are mounted on the inner sub-cover;
the conductor connected to the main circuit board passes through the second through hole of the inner cover, the wire hole of the first side plate of the housing, the wire hole of the second side plate of the housing, the first through hole of the outer cover of the outdoor component sequentially, and then extends into the outer main housing of the outdoor component to connect to the command-signal verification element.

6. The replacement storefront door lock with no drilling of claim 5, wherein the wire hole of the first side plate, the wire hole of the second side plate and the first through hole are substantially aligned.

7. The replacement storefront door lock with no drilling of claim 1, wherein the wire hole is formed adjacent the drive shift and offset from the drive shift.

8. The replacement storefront door lock with no drilling of claim 1, wherein electronic assembly further comprises a battery, the battery is connected to the motor and the command-signal verification element to power the motor and the command-signal verification element.

9. The replacement storefront door lock with no drilling of claim 1, wherein the mortise further comprises a drive rod movably located in the housing and being movable relative to the bolt; the drive shift is configured to couple with the tailpiece and receive drive from the tailpiece to rotate around a first direction, thereby driving the drive rod to move in the housing, and drive shift drives the bolt to extend or retract directly or indirectly via the drive rod.

10. The replacement storefront door lock with no drilling of claim 9, wherein the tailpiece extends through the mortise in a lateral direction, the bolt is movable in an in-out direction perpendicular to the lateral direction so as to extend out from or retract into the housing, and in a longitudinal direction perpendicular to the lateral direction and the in-out direction, the bolt is offset from the tailpiece.

11. The replacement storefront door lock with no drilling of claim 9, wherein the drive rod is rotatably connected to the housing about a first axis, the bolt is rotatably connected to the housing about a second axis, the drive shift is drivingly coupled to the tailpiece and is rotatably mounted relative to the housing about a third axis to make the drive shift being capable of driving by the tailpiece; one end of the drive rod, located on one side of the first axis, is movably connected to one end of the drive shift, which is away from the third axis; the other end of the drive rod, located on the other side of the first axis, is movably connected to the bolt.

12. The replacement storefront door lock with no drilling of claim 9, wherein the mortise further comprises an elastic element resists between the drive rod and the bolt to push the drive rod to move toward the drive shift; the drive shift is movably disposed in the housing, the bolt is slidably disposed in the housing for linear reciprocation, the drive rod is movable in a direction perpendicular to the direction of movement of the bolt, the drive shift is configured to resist the bolt and driving the bolt to move under pushing of the drive rod; the drive shift is connected to the tailpiece and is rotatably mounted in the mortise to drive the drive rod and the bolt to move.

13. The replacement storefront door lock with no drilling of claim 12, wherein at least one driving slot is defined in the bolt, and a positioning slot is defined in the housing; a protrusion is formed on a middle of a top portion of the positioning slot, and a positioning sub-slot is defined on each side of the protrusion; the drive rod is movably disposed in the driving slot in the vertical direction, a positioning block is formed on the drive rod, and the positioning block movably extends into the positioning slot; one driving slot is defined in each of two sides of the drive rod and the driving slot is located between the bolt and the drive shift, one end of the drive shift is swingable between the two driving slots and is capable of abutting against either driving slot.

14. The replacement storefront door lock with no drilling of claim 12, wherein at least one driving slot is defined in the bolt, and a positioning slot is defined in the housing; a protrusion is formed on a middle of a top portion of the positioning slot, and a positioning sub-slot is defined on each side of the protrusion; the drive rod is movably disposed in the driving slot in the vertical direction, and a positioning block is formed on the drive rod and the positioning block movably extends into the positioning slot; a side of the bolt facing the drive shift defines two spaced resisting surfaces, the two resisting surfaces resist a top of two sides of the drive shift respectively; one end of the drive shift is movable between the two resisting surfaces and is capable of abutting against either resisting surface.

15. The replacement storefront door lock with no drilling of claim 13, wherein the drive rod has a resisting portion on a side of the drive rod in contact with the drive shift, and the resisting portion protrudes towards the drive shift, one end of the elastic member resists the resisting portion.

16. The replacement storefront door lock with no drilling of claim 14, wherein the drive rod has a resisting portion on a side of the drive rod in contact with the drive shift, and the resisting portion protrudes towards the drive shift, one end of the elastic member resists the resisting portion.

17. The replacement storefront door lock with no drilling of claim 10, wherein the drive shift is connected to the tailpiece and is rotatably mounted within the mortise to drive the drive rod to translate, thereby causing the latch to move; the drive shift is separate from the drive rod, with the drive rod located in a rotational path of the drive shift; the mortise further comprises a first reset element and a second reset element, and when the driving force of the tailpiece is removed, the first reset element mounted on the drive shift drives the drive shift to reset in a second direction opposite to the first direction, and the bolt extends and resets under action of the second reset element connected to the bolt.

18. A replacement storefront door lock with no drilling, configured to be mounted on a first component of a storefront door so as to lock or unlock the first component relative to a second component, the replacement storefront door lock with no drilling comprising:
an outdoor component configured to mounted at an outer side of the first component;
an indoor component configured to mounted at an inner side of the first component;
a mortise, disposed between the outdoor component and the indoor component, the mortise comprising a housing, a bolt and a drive shift, the bolt movably disposed in the housing, and the housing defining a wire hole;
a tailpiece, rotatably disposed and engaged with the drive shift, the drive shift configured to receive a driving from the tailpiece to rotate to push the bolt to extend or retract; and
an electronic assembly, comprising a first electronic element mounted on the indoor component and a second electronic element mounted on the outdoor component, the first electronic element and the second electronic element are electrically connected to each other via a conductor;
wherein the conductor passes through the wire hole of the housing to transmit electronic signals.
